(19) United States
(12) Patent Application Publication
(10) Pub. No.: US 2025/0352412 A1
(43) Pub. Date: Nov. 20, 2025

(54) DRIVING SYSTEM, ELECTRIC WHEELCHAIR, CONTROL METHOD, AND NONTRANSITORY COMPUTER READABLE MEDIUM INCLUDING COMPUTER PROGRAM

(71) Applicant: YAMAHA HATSUDOKI KABUSHIKI KAISHA, Iwata-shi (JP)

(72) Inventor: Masamitsu MIZUNO, Shizuoka (JP)

(21) Appl. No.: 19/210,038

(22) Filed: May 16, 2025

(30) Foreign Application Priority Data
May 20, 2024 (JP) 2024-082108

(51) Int. Cl. A61G 5/04; B60L 15/20

(52) U.S. Cl. CPC A61G 5/043; B60L 15/20; A61G 2203/30; B60L 2200/34

(57) ABSTRACT

A driving system for use in an electric wheelchair includes at least one electric motor, a battery to supply power to the at least one electric motor, a controller configured or programmed to control operation of the at least one electric motor, a speed sensor to output a signal regarding a travel speed of the electric wheelchair, and a current sensor to output a signal regarding a current flowing through an electric path between the at least one electric motor and the battery. The controller is configured or programmed to obtain a current value of a charging current generated by regenerative braking to charge the battery and to decelerate the travel speed of the electric wheelchair based on the current value.

### CROSS REFERENCE TO RELATED APPLICATIONS

This application claims the benefit of priority to Japanese Patent Application No. 2024-082108 filed on May 20, 2024. The entire contents of this application are hereby incorporated herein by reference.

### BACKGROUND OF THE INVENTION

### 1. Field of the Invention

The present invention relates to driving systems, electric wheelchairs, control methods, and non-transitory computer readable media including computer programs.

### 2. Description of the Related Art

An electric wheelchair that travels using an electric motor as the driving source has been known in the art (see, for example, Japanese Laid-Open Patent Publication No. 5-095976). With an electric wheelchair, for example, the electric motor is caused to generate rotation in response to a user operation on the controller, and the rotation of the electric motor is transmitted to the wheels, thereby causing the electric wheelchair to travel.

By generating a braking force by regenerative braking when an electric wheelchair is traveling downhill, for example, it is possible to prevent the travel speed of the electric wheelchair from becoming too high.

By charging the battery with the current generated by regenerative braking, it is possible to increase the maximum travel distance of the electric wheelchair.

There is a need for more appropriate control of the charging of the battery using the current generated by regenerative braking of the electric wheelchair.

### SUMMARY OF THE INVENTION

Example embodiments of the present invention disclose driving systems, electric wheelchairs, control methods, and non-transitory computer readable media including computer programs as set forth below.

According to an example embodiment of the present invention, a driving system for use in an electric wheelchair includes at least one electric motor to generate a driving force to cause the electric wheelchair to travel, a battery to supply power to the at least one electric motor, a controller configured or programmed to control operation of the at least one electric motor, a speed sensor to output a signal regarding a travel speed of the electric wheelchair, and a current sensor to output a signal regarding a current flowing through an electric path between the at least one electric motor and the battery, wherein the controller is configured or programmed to obtain a current value of a charging current generated by regenerative braking to charge the battery, and decelerate the travel speed of the electric wheelchair based on the current value.

According to an example embodiment of the present invention, the travel speed of the electric wheelchair is decelerated based on the current value of the charging current generated by regenerative braking. Thus, it is possible to reduce or prevent the charging current generated by regenerative braking from becoming too large when traveling downhill, for example.

In the driving system above, the controller is configured or programmed to determine whether or not the current value is equal to or greater than a first threshold value, and decelerate the travel speed of the electric wheelchair when it is determined that the current value is equal to or greater than the first threshold value.

By decelerating the travel speed of the electric wheelchair when the current value is equal to or greater than the first threshold value, it is possible to reduce or prevent the charging current from becoming too large.

In the driving system above, the controller is configured or programmed to control operation of the electric motors so that the travel speed of the electric wheelchair is less than or equal to an upper limit speed value, which is an upper limit value of the travel speed, and decrease the upper limit speed value based on the current value.

It is possible to decelerate the travel speed of the electric wheelchair by decreasing the upper limit speed value.

In the driving system above, the controller is configured or programmed to determine whether or not the current value is equal to or greater than the first threshold value, and decrease the upper limit speed value when it is determined that the current value is equal to or greater than the first threshold value.

The upper limit speed value is decreased when the current value is equal to or greater than the first threshold value thus decelerating the travel speed of the electric wheelchair, and it is possible to reduce or prevent the charging current from becoming too large.

In the driving system above, when it is determined that the current value is not equal to or greater than the first threshold value, the controller is configured or programmed to not decrease the upper limit speed value.

By not decreasing the upper limit speed value when the current value is less than the first threshold value, the electric wheelchair can travel at a travel speed that matches the intention of the user.

In the driving system above, when it is determined that the current value is equal to or greater than the first threshold value, the controller is configured or programmed to decrease the upper limit speed value by a first predetermined value.

The upper limit speed value is decreased by the first predetermined value thus decelerating the travel speed of the electric wheelchair, and it is possible to reduce or prevent the charging current from becoming too large.

In the driving system above, when it is determined that the current value is equal to or greater than the first threshold value, the controller is configured or programmed to decrease the upper limit speed value by a first predetermined value every first predetermined time.

The upper limit speed value is decreased by the first predetermined value every first predetermined time thus decelerating the travel speed of the electric wheelchair, and it is possible to reduce or prevent the charging current from becoming too large.

In the driving system above, when it is determined that the current value is equal to or greater than the first threshold value, the controller is configured or programmed to decrease the upper limit speed value by a first predetermined value, count time since the upper limit speed value was decreased by the first predetermined value, and further decrease the upper limit speed value by the first predetermined value when the counted time has become equal to first predetermined time.

The upper limit speed value is decreased by the first predetermined value every first predetermined time thus decelerating the travel speed of the electric wheelchair, and it is possible to reduce or prevent the charging current from becoming too large.

In the driving system above, the controller is configured or programmed to stop a control of decreasing the upper limit speed value based on the current value when the current value is no longer equal to or greater than the first threshold value after it is determined that the current value is equal to or greater than the first threshold value to decrease the upper limit speed value.

By stopping the control of decreasing the upper limit speed value when the charging current becomes small, it is possible to reduce or prevent the travel speed of the electric wheelchair from becoming too low.

In the driving system above, the controller is configured or programmed to determine whether or not the current value is equal to or greater than a second threshold value, which is greater than the first threshold value, and decrease the upper limit speed value by a second predetermined value when it is determined that the current value is equal to or greater than the second threshold value, wherein the second predetermined value is greater than the first predetermined value.

By increasing the rate at which to decelerate the travel speed of the electric wheelchair when the current value is equal to or greater than the second threshold value, it is possible to quickly achieve a state where the charging current is small.

In the driving system above, the first threshold value is smaller than a maximum charging current value of the battery.

Because the first threshold value is smaller than the maximum charging current value, even if the charging current increases temporarily during the process of decelerating the travel speed of the electric wheelchair, the charging current can be reduced or prevented from exceeding the maximum charging current value.

In the driving system above, the second threshold value is smaller than a maximum charging current value of the battery.

Because the second threshold value is smaller than the maximum charging current value, even if the charging current increases temporarily during the process of decelerating the travel speed of the electric wheelchair, the current value of the charging current can be reduced or prevented from exceeding the maximum charging current value.

The driving system above further includes a user interface to accept user operations, and the controller is configured or programmed to start a control of decelerating the travel speed of the electric wheelchair based on a user operation on the user interface, and change a rate at which to decelerate the travel speed of the electric wheelchair based on the current value.

Thus, when decelerating the travel speed in response to a user operation, the charging current generated by regenerative braking can be reduced or prevented from becoming too large.

In the driving system above, the controller is configured or programmed to increase the upper limit speed value when the current value has become less than or equal to a third threshold value, which is smaller than the first threshold value, after it is determined that the current value is equal to or greater than the first threshold value to decrease the upper limit speed value.

By increasing the upper limit speed value when the charging current has become sufficiently small, it is possible to reduce or prevent the travel speed from continuing to be restricted to a low speed. For example, it is possible to reduce or prevent the travel speed from continuing to be restricted to a low speed even after moving from a downhill slope to a flat road.

In the driving system above, when it is determined that the current value is less than or equal to the third threshold value, the controller is configured or programmed to count time since it was determined that the current value is less than or equal to the third threshold value, and increase the upper limit speed value by a third predetermined value when the counted time has become equal to second predetermined time.

By increasing the upper limit speed value after elapse of the second predetermined time since it was determined that the current value is less than or equal to the third threshold value, it is possible to reduce or prevent the travel speed from increasing when the charging current decreases temporarily. Moreover, the transition from deceleration to acceleration can be done smoothly.

In the driving system above, after the counted time has become equal to the second predetermined time and the upper limit speed value is increased by the third predetermined value, the controller is configured or programmed to increase the upper limit speed value by the third predetermined value every second predetermined time.

By increasing the upper limit speed value by the third predetermined value every second predetermined time, the travel speed can be smoothly increased.

In the driving system above, when the upper limit speed value has reached a predetermined maximum value, the controller is configured or programmed to stop a control of increasing the upper limit speed value, and maintain the upper limit speed value at the maximum value.

By stopping the control of increasing the upper limit speed value when the upper limit speed value has reached the predetermined maximum value, it is possible to reduce or prevent the travel speed of the electric wheelchair from becoming greater than the maximum value.

In the driving system above, when it is determined that the current value has become greater than the third threshold value after it is determined that the current value is less than or equal to the third threshold value and the upper limit speed value is increased, the controller is configured or programmed to stop the control of increasing the upper limit speed value, and maintain the current upper limit speed value.

By stopping the control of increasing the upper limit speed value when the charging current has become large, it is possible to reduce or prevent the charging current from becoming too large.

In the driving system above, the controller is configured or programmed to decelerate the travel speed of the electric wheelchair at least by regenerative braking.

By charging the battery with the current generated by regenerative braking, it is possible to increase the maximum travel distance of the electric wheelchair.

In the driving system above, the controller is configured or programmed to decelerate the travel speed of the electric wheelchair by increasing a braking force generated by regenerative braking based on the current value.

By increasing the braking force generated by regenerative braking, the charging current can increase temporarily, but the regenerative current decreases as the travel speed decreases so the charging current can be decreased.

According to an example embodiment of the present invention, an electric wheelchair includes the driving system according to any of the example embodiments of the present invention described above.

It is possible to realize the electric wheelchair in which the charging current generated by regenerative braking can be reduced or prevented from becoming too large.

According to an example embodiment of the present invention, a control method to be executed by a computer for controlling a charging current to charge a battery of an electric wheelchair, the battery configured to supply power to at least one electric motor to generate a driving force to cause the electric wheelchair to travel, the control method includes obtaining a current value of the charging current generated by regenerative braking to charge the battery, and decelerating a travel speed of the electric wheelchair based on the current value.

According to an example embodiment of the present invention, the travel speed of the electric wheelchair is decelerated based on the current value of the charging current generated by regenerative braking. Thus, it is possible to reduce or prevent the charging current generated by regenerative braking from becoming too large when traveling downhill, for example.

A non-transitory computer readable medium including a computer program to cause a computer to execute a process of controlling a charging current to charge a battery of an electric wheelchair, the battery configured to supply power to at least one electric motor to generate a driving force to cause the electric wheelchair to travel, the computer program causing the computer to obtain a current value of the charging current generated by regenerative braking to charge the battery, and decelerate a travel speed of the electric wheelchair based on the current value.

According to an example embodiment of the present invention, the travel speed of the electric wheelchair is decelerated based on the current value of the charging current generated by regenerative braking. Thus, it is possible to reduce or prevent the charging current generated by regenerative braking from becoming too large when traveling downhill, for example.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a right side view showing an electric wheelchair according to an example embodiment of the present invention.

FIG. 2 is a perspective view showing the electric wheelchair according to an example embodiment of the present invention.

FIG. 3 is a block diagram showing a driving unit 10 of the electric wheelchair according to an example embodiment of the present invention.

FIG. 4 is a block diagram showing the current path between a battery, drive circuits, and electric motors.

FIG. 5 is a flow chart showing an example of a process of decelerating the travel speed of the electric wheelchair based on the value of the charging current generated by regenerative braking according to an example embodiment of the present invention.

FIG. 6 is a diagram showing an example of the relationship between the upper limit speed value and time according to an example embodiment of the present invention.

FIG. 7 is a diagram showing an example of the relationship between the travel speed, the charging current, and time according to an example embodiment of the present invention.

FIG. 8 is a flow chart showing another example of a process of decelerating the travel speed of the electric wheelchair based on the value of the charging current generated by regenerative braking according to an example embodiment of the present invention.

FIG. 9 is a flow chart showing another example of a process of decelerating the travel speed of the electric wheelchair based on the value of the charging current generated by regenerative braking according to an example embodiment of the present invention.

FIG. 10 is a diagram showing another example of the relationship between the upper limit speed value and time according to an example embodiment of the present invention.

FIG. 11 is a flow chart showing an example of a process of increasing the upper limit speed value according to an example embodiment of the present invention.

FIG. 12 is a flow chart showing an example of a process of increasing the upper limit speed value according to an example embodiment of the present invention.

FIG. 13 is a diagram showing yet another example of the relationship between the upper limit speed value and time according to an example embodiment of the present invention.

FIG. 14 is a flow chart showing another example of a process of increasing the upper limit speed value according to an example embodiment of the present invention.

FIG. 15 is a flow chart showing another example of a process of increasing the upper limit speed value according to an example embodiment of the present invention.

### DETAILED DESCRIPTION OF THE EXAMPLE EMBODIMENTS

Example embodiments of the present invention will now be described with reference to the drawings. Like elements are denoted by like reference signs, and will not be described redundantly. The designations F, Re, L, R, U and D, as used in the figures, refer to front, rear, left, right, up and down, respectively. The terms front, rear, left, right, up, and down, refer to these directions as seen from a user seated on a seat of an electric wheelchair.

While an electric wheelchair to be illustrated below is an electric wheelchair that can travel using only the driving force generated by an electric motor, the electric wheelchair is not limited thereto. The electric wheelchair may be a power assisted wheelchair in which the pushing of the handrim by a person is assisted by an electric motor. Alternatively, the electric wheelchair may be a handle-type electric wheelchair. The following example embodiments are illustrative, and the present invention is not limited to the following example embodiments.

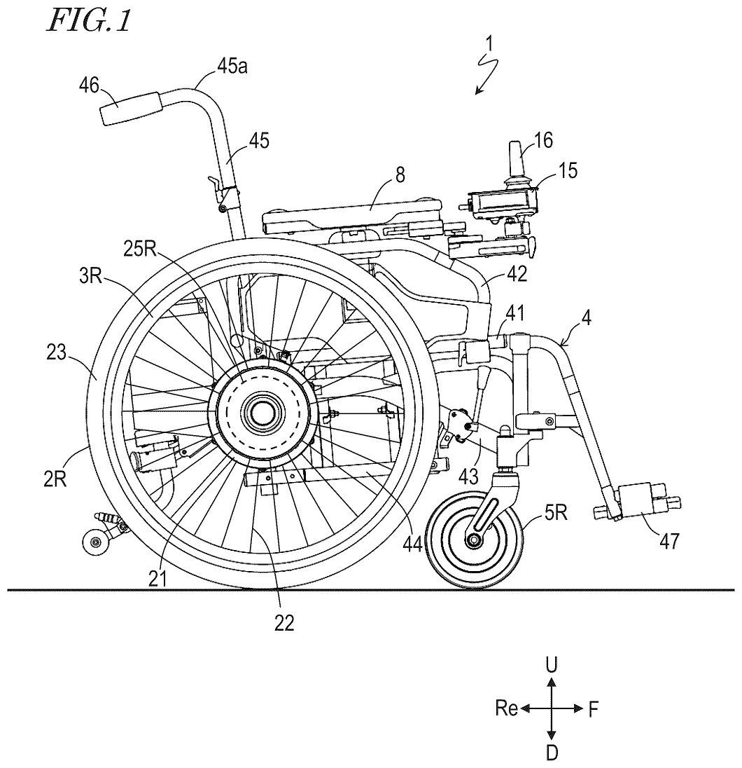

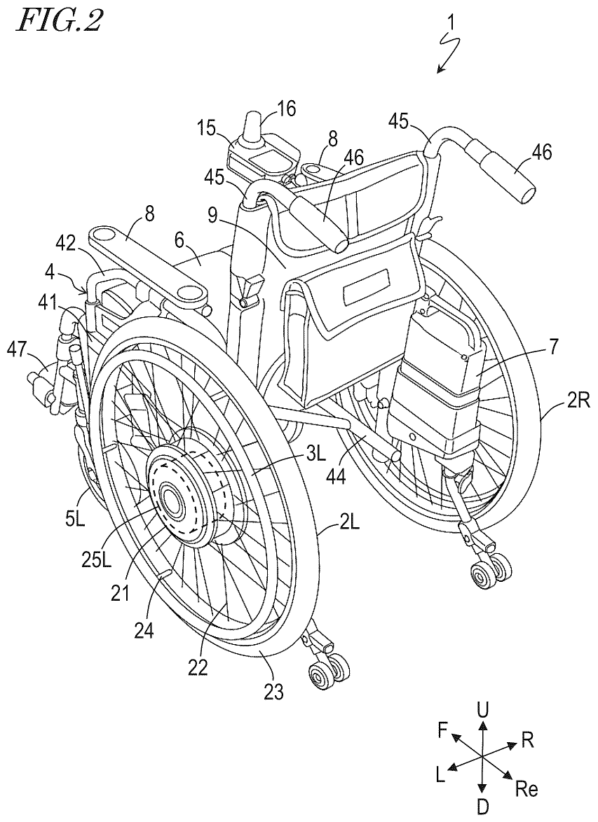

FIG. 1 is a right side view showing an electric wheelchair 1 according to an example embodiment of the present invention. FIG. 2 is a perspective view showing the electric wheelchair 1 as viewed from the left rear side.

The electric wheelchair 1 includes a vehicle frame 4 made of metal pipes, etc. The vehicle frame 4 rotatably supports a pair of left and right wheels 2L and 2R and a pair of left and right casters 5L and 5R. The vehicle frame 4 includes a pair of left and right seat frames 41, a pair of left and right armrest frames 42, a pair of left and right base frames 43, a pair of left and right under frames 44, and a pair of left and right back frames 45.

A seat 6 for a human to sit on is provided between the pair of left and right seat frames 41. The front portion of the seat frame 41 is bent downward, and a footrest 47 is provided at the lower end of the front portion of the seat frame 41. The rear end of the seat frame 41 is connected to the back frame 45. The back frame 45 extends in the up-down direction. A backrest 9 is provided between the pair of left and right back frames 45. In FIG. 1, the backrest 9 is omitted in order to clearly show the shape of the back frame 45.

The back frame 45 includes a handlebar 45a that is bent and extends backward at its upper portion. The handlebar 45a is provided with a hand grip 46 to be held by a hand of a caregiver.

The base frame 43 and the under frame 44 are arranged below the seat frame 41. The armrest frame 42 is arranged above the seat frame 41. The armrest frame 42 is provided with an armrest 8 on which a person seated on the seat 6 can place his/her arm.

The wheel 2L is provided with a handrim 3L used to drive the wheel 2L by human power. The wheel 2R is provided with a handrim 3R to drive the wheel 2R by human power. Each of the wheels 2L and 2R includes a wheel hub 21, an outer circumference portion 23 surrounding the wheel hub 21, and a plurality of spokes 22. The plurality of spokes 22 connect between the wheel hub 21 and the outer circumference portion 23. The outer circumference part 23 includes a rim to which the spokes 22 are connected and a tire attached to the rim. The handrims 3L and 3R are connected to a plurality of connecting members 24 extending from the outer circumference portion 23 of the wheels 2L and 2R.

The wheel hub 21 of the wheel 2L is provided with an electric motor 25L. The wheel hub 21 of the wheel 2R is provided with an electric motor 25R. The electric motors 25L and 25R are, for example, hub motors. The wheel hub 21 includes an axle, a first housing located on the inner side of the electric wheelchair 1 in the left-right direction, and a second housing located on the outer side. The first housing on the inner side is fixed to the axle, and the second housing on the outer side is rotatable relative to the axle. The stators of the electric motors 25L and 25R are fixed to the first housing and the axle, and the rotors of the electric motors 25L and 25R are fixed to the second housing. The plurality of spokes 22 are connected to the second housing.

The axle of the wheel hub 21 is fixed to the vehicle frame 4. The axle of the wheel hub 21 is fixed to the back frame 45, for example. The axle of the wheel hub 21 may be fixed to the vehicle frame 4 via a bracket provided between the seat frame 41 and the under frame 44. The wheels 2L and 2R rotate by the rotation of the second housing relative to the axle fixed to the vehicle frame 4 and the first housing.

The electric wheelchair 1 is provided with a battery 7 to supply power to the electric motors 25L and 25R. When power is supplied to the electric motors 25L and 25R, the rotor fixed to the second housing rotates relative to the stator fixed to the first housing, thus rotating the wheels 2L and 2R.

The electric motors 25L and 25R are not limited to hub motors, and may be provided outside the wheel hub 21. In this case, the rotation generated by the electric motors 25L and 25R can be transmitted to the wheel hub 21 via a reduction gear.

An operation unit 15 is provided at the front of the armrest 8 for a user seated on the seat 6 to operate the electric wheelchair 1. The operation unit 15 is an example of a user interface that accepts user operations. The operation unit 15 includes a stick 16 (e.g., a joystick), and when the stick 16 of the operation unit 15 is tilted by hand, the electric motors 25L and 25R generate rotation and the electric wheelchair 1 can travel. The degree to which the stick 16 is tilted can be adjusted to control the travel speed. When the stick 16 is returned to the neutral position, the drive of the electric motors 25L and 25R stops, and the electric wheelchair 1 can be stopped.

An operation unit for a caregiver to operate the electric wheelchair 1 may be provided on the handlebar 45a of the back frame 45.

Next, the driving unit of the electric wheelchair 1 will be described.

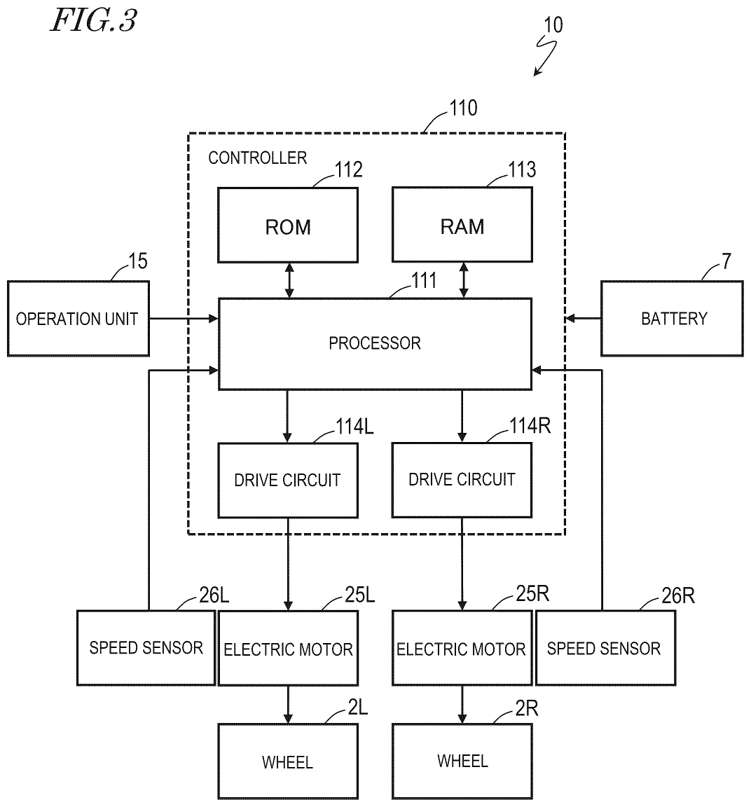

FIG. 3 is a block diagram showing the driving unit 10 included in the electric wheelchair 1. The driving unit 10 is a driving system that drives the electric motors 25L and 25R by supplying current thereto, and also charges the battery 7 using the regenerative current generated by the electric motors 25L and 25R. The driving unit 10 includes a controller 110, the operation unit 15, the battery 7, the electric motors 25L and 25R, speed sensors 26L and 26R, and the wheels 2L and 2R. The driving unit 10 generates a driving force in the electric motors 25L and 25R in response to operation on the operation unit 15, thus causing the electric wheelchair 1 to travel.

The controller 110 includes a processor 111, a recording medium such as a ROM (Read-Only Memory) 112 and a RAM (Random Access Memory) 113, and drive circuits 114L and 114R. The ROM 112 includes a computer program (or firmware) stored therein in advance to cause the processor 111 to perform various processes. The computer program may be provided to the driving unit 10 via a storage medium (e.g., a semiconductor memory) or an electrical communication line (e.g., the Internet). Such a computer program may be sold as commercial software.

The processor 111 may be a semiconductor integrated circuit, and includes a central processing unit (CPU), for example. The processor 111 can be implemented by a microprocessor or a microcontroller. The processor 111 sequentially executes a computer program (the computer program stored in the ROM 112) that describes a group of instructions for performing various processes to achieve desired processing.

The processor 111 may be an FPGA (Field Programmable Gate Array), a GPU (Graphics Processing Unit), an ASIC (Application Specific Integrated Circuit), an ASSP (Application Specific Standard Product), which are provided with a CPU, or a combination of two or more of these circuits.

The ROM 112 may be, for example, a writable memory (e.g., a PROM), a rewritable memory (e.g., a flash memory), or a read-only memory. The ROM 112 does not need to be a single storage medium, and it may be a collection of recording mediums. The RAM 113 provides a work area for temporarily expanding the computer program stored in the ROM 112 upon boot. The RAM 113 does not need to be a single recording medium, and it may be a collection of recording mediums.

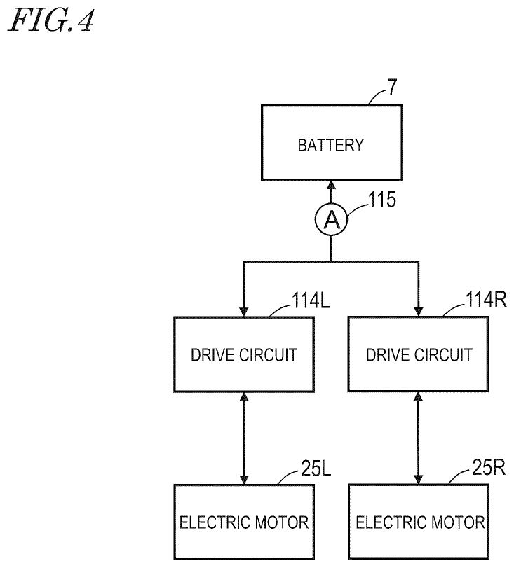

FIG. 4 is a block diagram showing the current path between the battery 7, the drive circuits 114L and 114R, and the electric motors 25L and 25R.

The drive circuits 114L and 114R may be, for example, bidirectional converters. When the electric motors 25L and 25R are driven by supplying current thereto, the drive circuits 114L and 114R operate as inverters that convert direct current output from the battery 7 to alternating current. The drive circuits 114L and 114R generate a drive current according to the current-specifying value output from the processor 111 and supply the drive current to the electric motors 25L and 25R.

When charging the battery 7 using the regenerative current generated by electric motors 25L and 25R by regenerative braking, the drive circuits 114L and 114R operate as converters that convert the alternating current output from electric motors 25L and 25R to direct current. The direct current output from the drive circuits 114L and 114R is supplied to the battery 7 as the charging current, thus charging the battery 7.

A current sensor 115 detects the current value of the output current of the battery 7 and the value of the charging current for charging the battery 7 generated by regenerative braking.

The speed sensors 26L and 26R output signals related to the travel speed of the electric wheelchair 1. In the present example embodiment, the speed sensors 26L and 26R detect the rotation angles of the electric motors 25L and 25R. The travel speed of the electric wheelchair 1 can be calculated from the rotation angles of the electric motors 25L and 25R.

The speed sensor 26L is provided in the electric motor 25L. The speed sensor 26R is provided in the electric motor 25R. The speed sensors 26L and 25R may be, for example, encoders. The speed sensor 26L detects the rotation angle of the rotor of the electric motor 25L and outputs a signal corresponding to the rotation angle to the controller 110. The speed sensor 26R detects the rotation angle of the rotor of the electric motor 25R and outputs a signal corresponding to the rotation angle to the controller 110.

The controller 110 can be provided in the wheel hub 21 of the wheel 2L or the wheel 2R. Elements of the controller 110 may be distributed between the wheel hub 21 of the wheel 2L and the wheel hub 21 of the wheel 2R. For example, the drive circuit 114L may be arranged in the wheel hub 21 of the wheel 2L, and the drive circuit 114R may be arranged in the wheel hub 21 of the wheel 2R. The controller 110 may be arranged independently of the wheel hub 21. The processor 111 of the controller 110 calculates the rotational speed of the electric motors 25L and 25R from the output signals of the speed sensors 26L and 26R. The tire size of the wheels 2L and 2R is known in advance, and the processor 111 can calculate the travel speed of the electric wheelchair 1 from the rotational speed of the electric motors 25L and 25R. When the rotation of the electric motors 25L and 25R is transmitted to the wheels 2L and 2R via a reduction gear, the travel speed of the electric wheelchair 1 is calculated by further using the information on the reduction ratio of the reduction gear. Thus, the travel speed of the electric wheelchair 1 can be calculated using the output signals of the speed sensors 26L and 26R.

The speed sensors 26L and 26R may be provided in the wheel hubs 21, the outer circumference portion 23, or the spokes 22 of the wheels 2L and 2R. The speed sensors 26L and 26R may output signals corresponding to the rotation of the elements in which the speed sensors 26L and 26R are provided.

The operation unit 15 outputs a signal corresponding to the operation of the stick 16 by a user seated on the seat 6 to the controller 110. The processor 111 calculates the target value of the rotation speed of the electric motors 25L and 25R based on the output signal from the operation unit 15. The processor 111 calculates the target value of the rotation speed by referring to a map indicating, for example, the relationship between the amount of operation on the stick 16 of the operation unit 15 and the rotation speed of the electric motors 25L and 25R.

The processor 111 calculates the current rotational speed of the electric motors 25L and 25R from the output signals of the speed sensors 26L and 26R, and calculates the current-specifying value to reduce the deviation between the current rotational speed and the target value.

The processor 111 outputs the calculated current-specifying value to the drive circuits 114L and 114R. The drive circuits 114L and 114R generate drive current corresponding to the current-specifying value, and supply the drive current to the electric motors 25L and 25R. The electric motors 25L and 25R, having received the drive current, generate rotation. By performing feedback control so that the deviation between the current rotation speed of the electric motors 25L and 25R and the target value becomes small, the electric wheelchair 1 can travel at a travel speed corresponding to the operation amount of the operation unit 15. The driving unit 10 may be detachable from the vehicle frame 4 of the electric wheelchair 1. The driving unit 10 may also be detachable from a vehicle frame other than the vehicle frame 4. For example, by removing the wheels from the vehicle frame of a general wheelchair and attaching the driving unit 10 to the vehicle frame, the general wheelchair can be used as the electric wheelchair 1.

The driving unit 10 may not include the wheels 2L and 2R. In this case, the driving unit 10 may be attached to a wheelchair that includes wheels and handrims. The driving unit 10 may not include the operation unit 15. In this case, the driving unit 10 may be attached to a wheelchair that includes an operation unit. The driving unit 10 may not include the battery 7. In this case, power may be supplied to the driving unit 10 from a battery provided separately from the driving unit 10.

Next, the control of charging the battery using the current generated by regenerative braking will be described.

As described above, the processor 111 of the controller 110 causes the electric wheelchair 1 to travel at a travel speed corresponding to the amount of operation by the user on the operation unit 15. For example, the travel speed is increased in proportion to the angle at which the stick 16 of the operation unit 15 is tilted.

When the user returns the stick 16 to the neutral position while the electric wheelchair 1 is traveling, the processor 111 decelerates the travel speed so that the electric wheelchair 1 stops. The travel speed is decelerated by activating the regenerative braking. The regenerative braking refers to the rotational resistance generated in the electric motors 25L and 25R.

The electric wheelchair 1 includes an electromagnetic brake mechanism. After the electric wheelchair 1 has decelerated and stopped using the regenerative braking, the processor 111 activates the electromagnetic brake to maintain the stopped state of the electric wheelchair 1.

While the electric wheelchair 1 is traveling, if the user relaxes the operation on the stick 16 and the tilt angle of the stick 16 decreases, the processor 111 decelerates the travel speed so as to correspond to the decreased angle. The travel speed may be decelerated by activating the regenerative braking. When traveling downhill, for example, by running the electric wheelchair 1 while activating the regenerative braking, it is possible to maintain the travel speed corresponding to the amount of operation on the stick 16 and to prevent the travel speed from exceeding the upper limit speed value.

If the regenerative braking is activated as described above, the maximum travel distance of the electric wheelchair 1 can be increased by charging the battery 7 with the charging current generated by the regenerative braking.

The maximum charging current value, which is the recommended maximum value of charging current, is pre-set in the battery 7. The maximum charging current value is pre-set by the manufacturer of the battery 7, for example. It is desirable that the value of the charging current generated by regenerative braking does not exceed this maximum charging current value.

In the present example embodiment, the travel speed of the electric wheelchair 1 is decelerated based on the value of the charging current generated by regenerative braking. Thus, it is possible to reduce or prevent the charging current generated by regenerative braking from becoming too large when traveling downhill, for example.

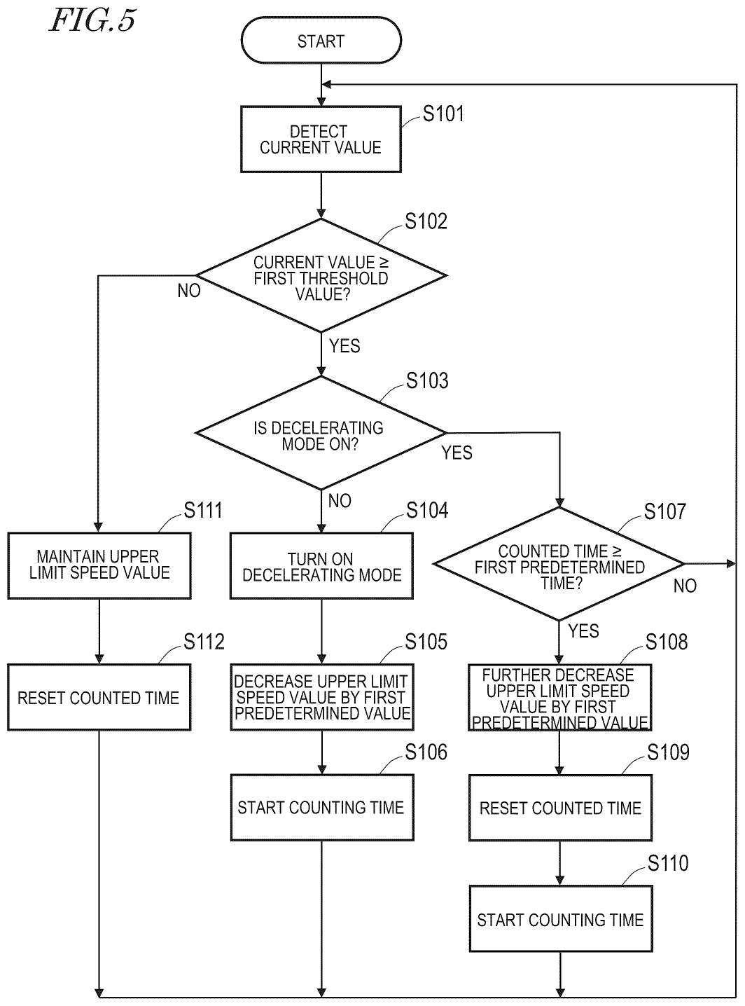

FIG. 5 is a flow chart showing an example of the process of decelerating the travel speed of the electric wheelchair 1 based on the value of the charging current generated by regenerative braking.

The upper limit speed value, which is the upper limit value of the travel speed, is pre-set in the electric wheelchair 1. As an example, the upper limit speed value is 6 km/h, but there is no limitation to the value. For example, when the amount of operation by the user on the operation unit 15 is at a maximum, the processor 111 controls the operation of the electric motors 25L and 25R so that the travel speed is 6 km/h. The processor 111 controls the operation of the electric motors 25L and 25R so that the travel speed of the electric wheelchair 1 does not exceed the upper limit speed value.

For example, when the electric wheelchair 1 that is traveling at 6 km/h or a speed of slightly less than 6 km/h enters a downhill slope from a flat road, the wheelchair 1 will be subject to a force of gravity that will cause the wheelchair 1 to accelerate forward. If the slope angle of the downhill slope is relatively large, the force of gravity that causes the wheelchair 1 to accelerate forward is large. The processor 111 controls the operation of the electric motors 25L and 25R so that the travel speed of the electric wheelchair 1 does not exceed the upper limit speed value.

For example, the processor 111 stops supplying drive current to the electric motors 25L and 25R, and causes the drive circuits 114L and 114R to operate as converters to generate a braking force by regenerative braking. The drive circuits 114L and 114R convert the alternating current output from the electric motors 25L and 25R to direct current, and supply the direct current to the battery 7 as the charging current, thus charging the battery 7. As described above, the maximum charging current value is pre-set in the battery 7. The processor 111 controls the charging so that the value of the charging current generated by regenerative braking does not exceed the maximum charging current value. The maximum charging current value is herein set to 18 A as an example, but the maximum charging current value is not limited to that value.

The processor 111 detects the value of the charging current for charging the battery 7 generated by regenerative braking from the output signal of the current sensor 115 (step S101). The processor 111 determines whether or not the detected current value is equal to or greater than the first threshold value (step S102). The first threshold value is less than the maximum charging current value set for battery 7. The first threshold value is herein set to 12 A as an example, but the first threshold value is not limited to that value.

When it is determined that the detected current value is not equal to or greater than the first threshold value, the processor 111 does not perform the process of decreasing the upper limit speed value to be described below, and maintains the current upper limit speed value (step S111).

When it is determined that the detected current value is equal to or greater than the first threshold value, the processor 111 determines whether or not the decelerating mode is ON (step S103). The “decelerating mode” as used in the present example embodiment means “an operation mode in which the upper limit speed value is decreased so that the value of the charging current generated by regenerative braking does not exceed the maximum charging current value”.

When it is determined that the decelerating mode is not ON, the processor 111 turns ON the decelerating mode and decreases the upper limit speed value by the first predetermined value (steps S104 and S105). The first predetermined value is herein set to 1 km/h as an example, but the first predetermined value is not limited to that value. For example, if the upper limit speed value is 6 km/h, the processor 111 decreases the upper limit speed value to 5 km/h.

The processor 111 decelerates the travel speed by controlling the magnitude of the regenerative braking force so that the travel speed of the electric wheelchair 1 does not exceed the decreased upper limit speed value. For example, the processor 111 increases the regenerative current and increases the braking force by adjusting the duty ratio of the PWM control of the drive circuits 114L and 114R. Thus, it is possible to decelerate the travel speed.

The processor 111 starts counting the time since the upper limit speed value was decreased by the first predetermined value (step S106), and returns to the process of step S101.

When it is determined that the detected current value is equal to or greater than the first threshold value, the processor 111 determines whether or not the decelerating mode is ON (steps S102 and S103). When it is determined that the decelerating mode is ON, the processor 111 proceeds to the process of step S107.

In step S107, the processor 111 determines whether or not the counted time has become equal to or greater than the first predetermined time. The first predetermined time is set to 1 second as an example, but the first predetermined time is not limited to that value.

When it is determined that the counted time has become equal to or greater than the first predetermined time, the processor 111 further decreases the upper limit speed value by the first predetermined value (step S108). For example, if the upper limit speed value is 5 km/h, the processor 111 decreases the upper limit speed value to 4 km/h. The processor 111 decelerates the travel speed by controlling the magnitude of the regenerative braking force so that the travel speed of the electric wheelchair 1 does not exceed the further decreased upper limit speed value.

The processor 111 resets the counted time and starts counting the time since the upper limit speed value was further decreased by the first predetermined value in step S108 (steps S109 and S110), and returns to the process of step S101.

As the travel speed of the electric wheelchair 1 gradually decreases, the charging current generated by regenerative braking also gradually decreases. In step S102, when it is determined that the detected current value is not equal to or greater than the first threshold value, the processor 111 maintains the current upper limit speed value (step S111). That is, the process of decreasing the upper limit speed value is stopped. If time is being counted, the counted time is reset (step S112).

In the present example embodiment, when it is determined that the value of the charging current is equal to or greater than the first threshold value, the travel speed of the electric wheelchair 1 is decelerated by decreasing the upper limit speed value. Thus, it is possible to reduce or prevent the charging current from becoming too large. When decelerating the travel speed, the upper limit speed value can be decreased by the first predetermined value every first predetermined time, thus smoothly decelerating the travel speed.

By stopping the process of decreasing the upper limit speed value when the value of the charging current is no longer equal to or greater than the first threshold value, it is possible to reduce or prevent the travel speed of the electric wheelchair 1 from becoming too low.

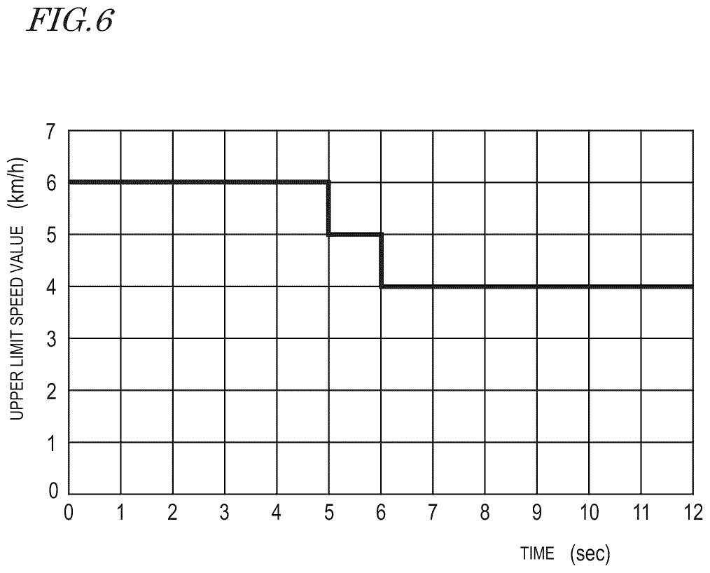

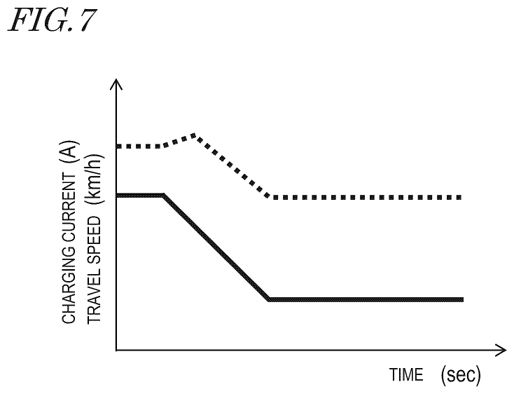

FIG. 6 is a diagram showing an example of the relationship between the upper limit speed value and time. FIG. 7 is a diagram showing an example of the relationship between the travel speed, the charging current, and time. The solid line in FIG. 7 shows the travel speed, and the dotted line shows the charging current.

In the example shown in FIG. 6, the upper limit speed value is decreased from 6 km/h to 5 km/h at the time of 5 seconds. The upper limit speed value is decreased from 5 km/h to 4 km/h at the time of 6 seconds. Thus, for example, by decreasing the upper limit speed value by 1 km/h every second, the travel speed of the electric wheelchair 1 can be smoothly decelerated.

By increasing the braking force generated by regenerative braking in order to decelerate the travel speed, the charging current can increase temporarily as shown in FIG. 7, but the regenerative current decreases as the travel speed decreases, so the charging current can be decreased.

Because the first threshold value described above is smaller than the maximum charging current value, even if the charging current increases temporarily during the process of decelerating the travel speed, the value of the charging current can be reduced or prevented from exceeding the maximum charging current value.

Next, another example of the process of decelerating the travel speed of the electric wheelchair 1 based on the value of the charging current generated by regenerative braking will be described.

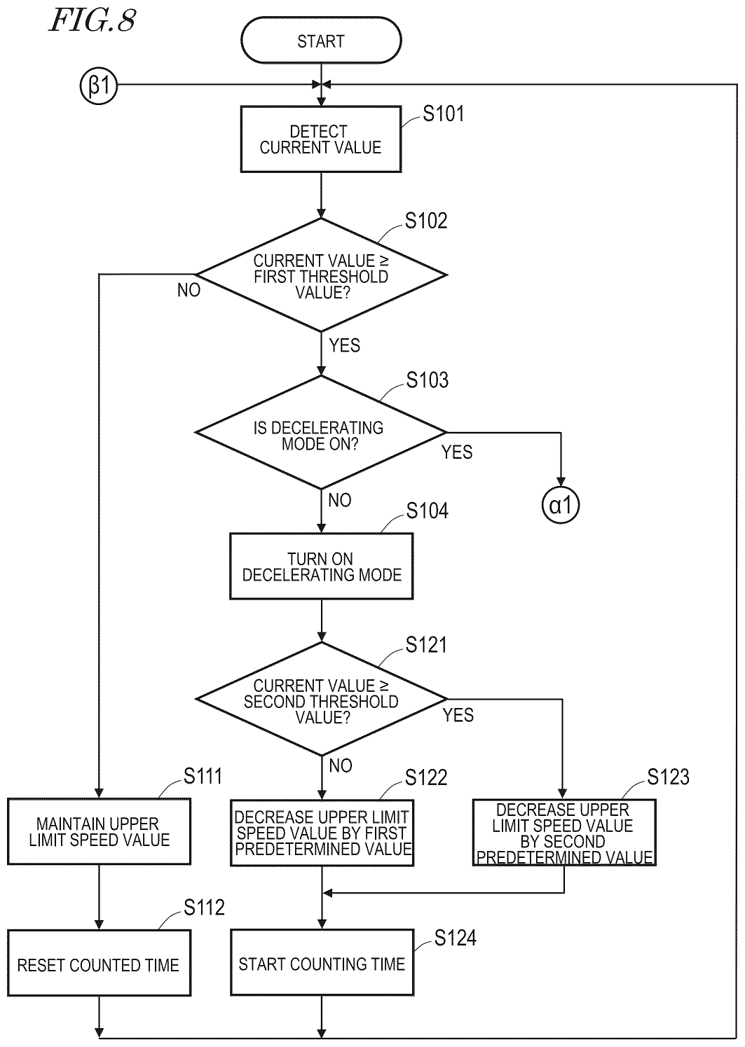

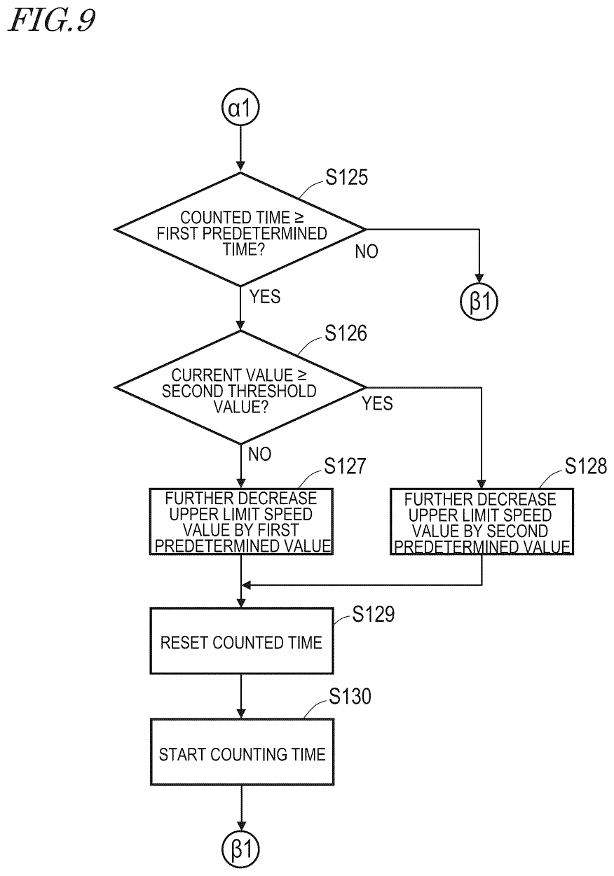

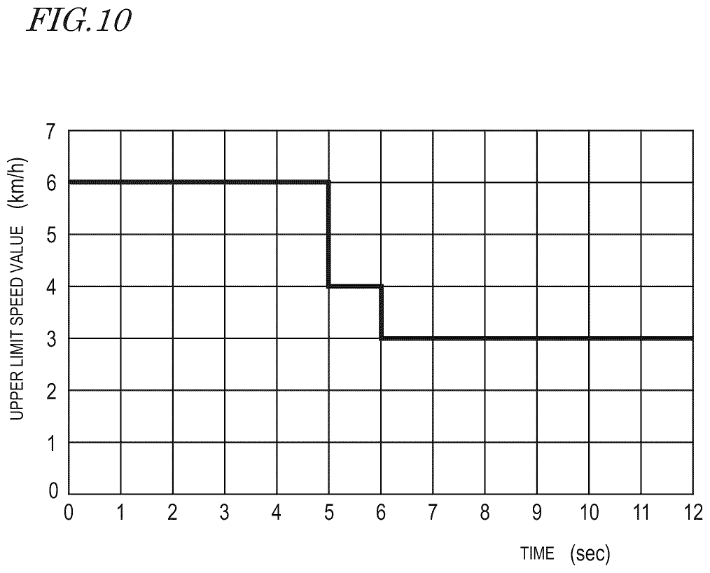

FIG. 8 and FIG. 9 are flow charts showing another example of the process of decelerating the travel speed of the electric wheelchair 1 based on the value of the charging current generated by regenerative braking. FIG. 10 is a diagram showing another example of the relationship between the upper limit speed value and time. In the example shown in FIG. 8 to FIG. 10, by increasing the rate at which to decelerate the travel speed of the electric wheelchair 1 when the value of the charging current is equal to or greater than the second threshold value, which is greater than the first threshold value, thus quickly achieving a state where the charging current is small.

The process of steps S101 to S104, S111, and S112 shown in FIG. 8 is the same as the process of steps S101 to S104, S111, and S112 shown in FIG. 5.

When it is determined in the process of step S103 shown in FIG. 8 that the decelerating mode is not ON, the processor 111 turns ON the decelerating mode (step S104). The processor 111 determines whether or not the detected value of the charging current is equal to or greater than the second threshold value (step S121). The second threshold value is greater than the first threshold value and is less than the maximum charging current value. The second threshold value is herein set to 15 A as an example, but the second threshold value is not limited to that value.

When it is determined that the detected current value is not equal to or greater than the second threshold value, the processor 111 decreases the upper limit speed value by the first predetermined value (step S122). For example, if the upper limit speed value is 6 km/h, the processor 111 decreases the upper limit speed value to 5 km/h. When it is determined that the detected current value is equal to or greater than the second threshold value, the processor 111 decreases the upper limit speed value by the second predetermined value (step S123). The second predetermined value is herein set to 2 km/h as an example, but the second predetermined value is not limited to that value. For example, if the upper limit speed value is 6 km/h, the processor 111 decreases the upper limit speed value to 4 km/h. The processor 111 decelerates the travel speed by controlling the magnitude of the regenerative braking force so that the travel speed of the electric wheelchair 1 does not exceed the decreased upper limit speed value.

The processor 111 starts counting the time since the upper limit speed value was decreased by the first predetermined value or the second predetermined value (step S124), and returns to the process of step S101 of FIG. 8.

When it is determined that the detected current value is equal to or greater than the first threshold value, the processor 111 determines whether or not the decelerating mode is ON (steps S102 and S103). In the example shown in FIG. 8 and FIG. 9, if the decelerating mode is ON, the processor 111 proceeds to the process of step S125.

In step S125, the processor 111 determines whether or not the counted time has become equal to or greater than the first predetermined time.

When it is determined that the counted time has become equal to or greater than the first predetermined time, the processor 111 determines whether or not the detected current value is equal to or greater than the second threshold value (step S126).

When it is determined that the detected current value is not equal to or greater than the second threshold value, the processor 111 further decreases the upper limit speed value by the first predetermined value (step S127). For example, if the upper limit speed value is 4 km/h, the processor 111 decreases the upper limit speed value to 3 km/h. When it is determined that the detected current value is equal to or greater than the second threshold value, the processor 111 further decreases the upper limit speed value by the second predetermined value (step S128). For example, if the upper limit speed value is 4 km/h, the processor 111 decreases the upper limit speed value to 2 km/h. The processor 111 decelerates the travel speed by controlling the magnitude of the regenerative braking force so that the travel speed of the electric wheelchair 1 does not exceed the decreased upper limit speed value.

The processor 111 resets the counted time (step S129). The processor 111 starts counting the time since the upper limit speed value was further decreased by the first predetermined value or the second predetermined value (step S130), and returns to the process of step S101 of FIG. 8.

In the example shown in FIG. 10, at the time of 5 seconds, it is determined that the value of the charging current is equal to or greater than the second threshold value, and the upper limit speed value is decreased from 6 km/h to 4 km/h. At the time of 6 seconds, it is determined that the value of the charging current is equal to or greater than the first threshold value and less than the second threshold value, and the upper limit speed value is decreased from 4 km/h to 3 km/h. By increasing the rate at which to decelerate the travel speed of the electric wheelchair 1 when the value of the charging current is equal to or greater than the second threshold value, it is possible to quickly achieve a state where the charging current is small.

Because the second threshold value described above is smaller than the maximum charging current value, even if the charging current increases temporarily during the process of decelerating the travel speed, the value of the charging current can be reduced or prevented from exceeding the maximum charging current value.

Next, the process of increasing the upper limit speed value will be described.

After the process of decreasing the upper limit speed value as described above, if the charging current has become sufficiently small, the upper limit speed value is increased. This can reduce or prevent the travel speed from continuing to be restricted to a low speed. For example, it is possible to reduce or prevent the travel speed from continuing to be restricted to a low speed even after the electric wheelchair 1 has moved from a downhill slope to a flat road.

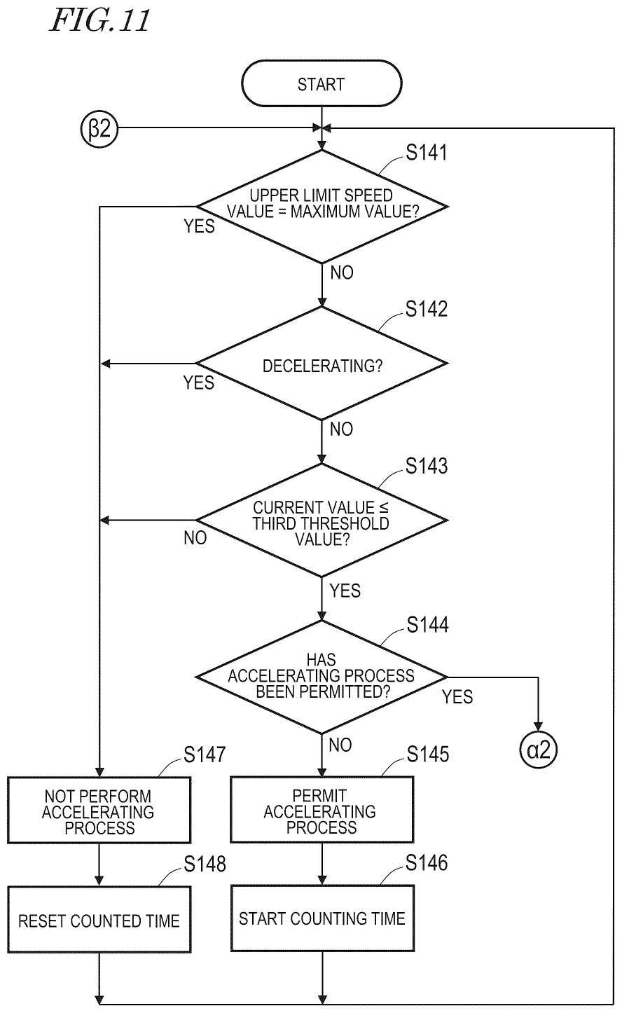

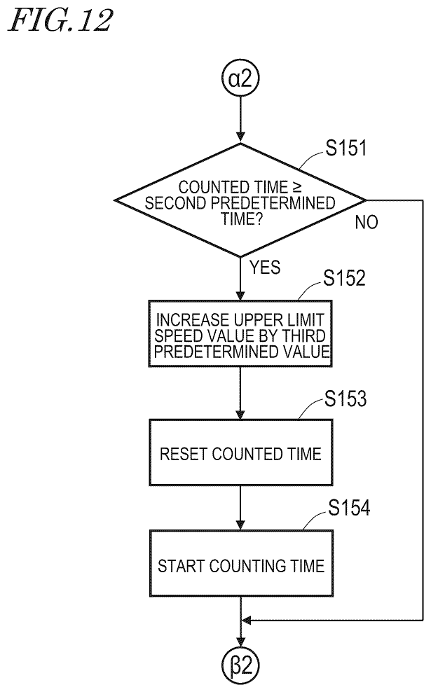

FIG. 11 and FIG. 12 are flow charts showing an example of the process of increasing the upper limit speed value.

The processor 111 determines whether or not the current upper limit speed value is equal to the maximum value (step S141). The maximum value of the upper limit speed value is set in advance in the electric wheelchair 1. The maximum value is 6 km/h as an example, but the maximum value is not limited to that value.

When it is determined that the current upper limit speed value is equal to the maximum value, the processor 111 does not perform the accelerating process to be described below (step S147).

After the process of decreasing the upper limit speed value as described above, the upper limit speed value is smaller than the maximum value. When it is determined that the current upper limit speed value is not the maximum value, the processor 111 determines whether or not the electric wheelchair 1 is decelerating (step S142). When it is determined that the electric wheelchair 1 is decelerating, the processor 111 does not perform the accelerating process (step S147).

When it is determined that the electric wheelchair 1 is not decelerating, the processor 111 determines whether or not the value of the charging current is less than or equal to the third threshold value (step S143). The third threshold value is less than the first threshold value. The third threshold value is herein set to 6 A as an example, but the third threshold value is not limited to that value. When it is determined that the value of the charging current is not less than or equal to the third threshold value, the processor 111 does not perform the accelerating process (step S147).

When it is determined that the value of the charging current is less than or equal to the third threshold value, the processor 111 determines whether or not the accelerating process has been permitted (step S144). In the present example embodiment, the “accelerating process” means “the process of increasing the upper limit speed value that has been decreased in the decelerating mode”.

When it is determined that the accelerating process has not been permitted, the processor 111 permits the accelerating process (step S145). The processor 111 starts counting the time since the accelerating process was permitted (step S146), and returns to the process of step S141. Since the process of steps S141 to S146 is performed in a short amount of time, “the time since the accelerating process was permitted” and “the time since it was determined that the value of the charging current is less than or equal to the third threshold value” are herein considered to be the same or substantially the same.

The processor 111 determines whether or not the accelerating process has been permitted after the process of steps S141 to S143 (step S144). If the accelerating process has been permitted, the processor 111 proceeds to the process of step S151 (FIG. 12).

In step S151, the processor 111 determines whether or not the counted time has become equal to or greater than the second predetermined time. The second predetermined time is set to 1 second as an example, but the second predetermined time is not limited to that value.

When it is determined that the counted time has become equal to or greater than the second predetermined time, the processor 111 increases the upper limit speed value by the third predetermined value (step S152). The third predetermined value is herein set to 1 km/h as an example, but the third predetermined value is not limited to that value. For example, if the upper limit speed value is 4 km/h, the processor 111 increases the upper limit speed value to 5 km/h.

The processor 111 resets the counted time and starts counting the time since the upper limit speed value was increased by the third predetermined value in step S152 (steps S153 and S154), and returns to the process of step S141.

When it is determined that the time counted has become equal to or greater than the second predetermined time after the process of steps S141 to S144, the processor 111 further increases the upper limit speed value by the third predetermined value (steps S151 and S152).

Thus, the processor 111 increases the upper limit speed value by the third predetermined value every second predetermined time. For example, the upper limit speed value is increased by 1 km/h every second. By increasing the upper limit speed value by the third predetermined value every second predetermined time, the travel speed can be smoothly increased.

If the value of the charging current has become greater than the third threshold value after increasing the upper limit speed value, the processor 111 stops the process of increasing the upper limit speed value, and maintains the current upper limit speed value (steps S143 and S147). If time is being counted, the counted time is reset (step S148). By stopping the process of increasing the upper limit speed value when the charging current has become large, it is possible to reduce or prevent the charging current from becoming too large.

If the upper limit speed value has reached the maximum value, the processor 111 stops the process of increasing the upper limit speed value, and maintains the upper limit speed value at the maximum value (steps S141 and S147). If time is being counted, the counted time is reset (step S148). By stopping the process of increasing the upper limit speed value when the upper limit speed value has reached the maximum value, it is possible to reduce or prevent the travel speed of the electric wheelchair 1 from becoming greater than the maximum value.

In the present example embodiment, when it is determined in step S143 that the value of the charging current is less than or equal to the third threshold value, the upper limit speed value is not increased immediately, but the upper limit speed value is increased after the time that started being counted in step S146 has reached the second predetermined time. By increasing the upper limit speed value after elapse of the second predetermined time since it was determined that the value of the charging current is less than or equal to the third threshold value, it is possible to reduce or prevent the travel speed from increasing when the charging current decreases temporarily. Moreover, the transition from deceleration to acceleration can be done smoothly.

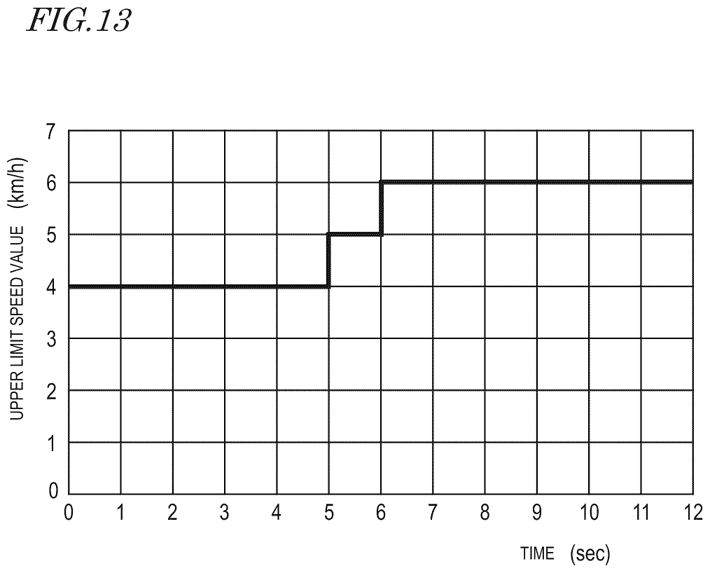

FIG. 13 is a diagram showing an example of the relationship between the upper limit speed value and time in the accelerating process. In the example shown in FIG. 13, the speed limit is increased from 4 km/h to 5 km/h at the time of 5 seconds. And the speed limit is increased from 5 km/h to 6 km/h at the time of 6 seconds. By thus increasing the speed limit by 1 km/h every second, for example, the travel speed of the electric wheelchair 1 can be smoothly increased.

Next, another example of the process of increasing the upper limit speed value will be described.

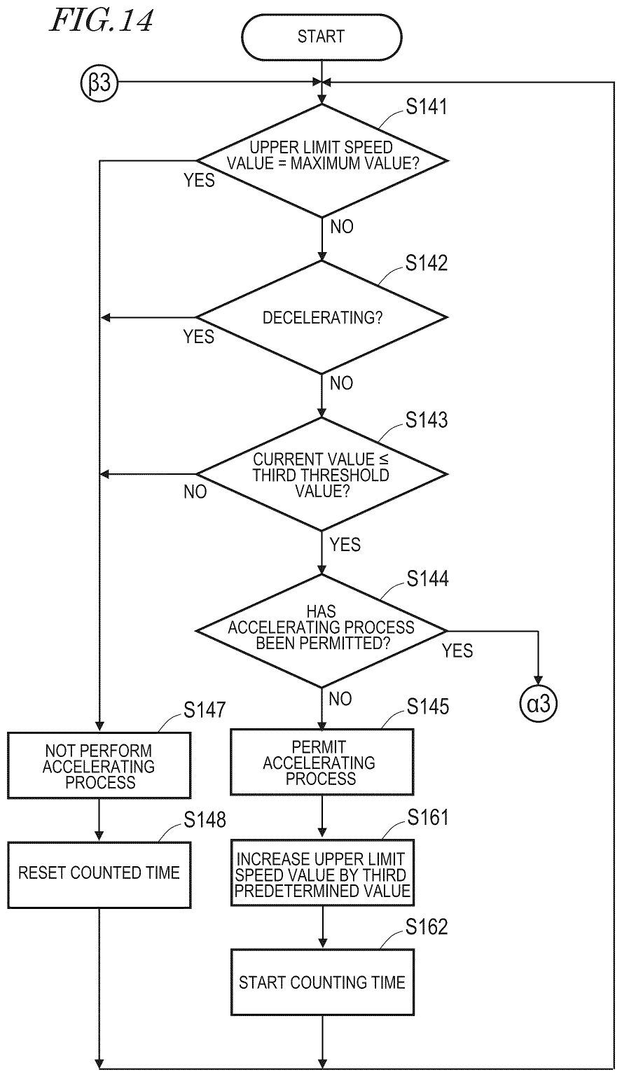

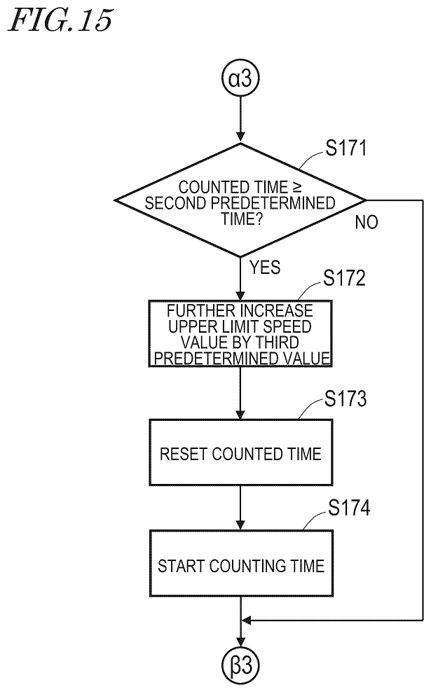

FIG. 14 and FIG. 15 are flow charts showing another example of the process of increasing the upper limit speed value. The process of steps S141 to S145, S147, and S148 shown in FIG. 14 is the same as the process of steps S141 to S145, S147, and S148 shown in FIG. 11. In the example shown in FIG. 14 and FIG. 15, if the accelerating process is permitted in the process of step S145, the upper limit speed value is immediately increased by the third predetermined value without waiting for elapse of the second predetermined time. For example, if the upper limit speed value is 4 km/h, the processor 111 increases the upper limit speed value to 5 km/h.

As shown in FIG. 14, when it is determined that the accelerating process has not been permitted in the process of step S144, the processor 111 permits the accelerating process and increases the upper limit speed value by the third predetermined value (steps S145 and S161). The processor 111 starts counting the time since the accelerating process was permitted (step S162), and returns to the process of step S141 of FIG. 14. Since the process of steps S141 to S145, S161, and S162 is performed in a short amount of time, “the time since the accelerating process was permitted” and “the time since it was determined that the value of the charging current is less than or equal to the third threshold value” are herein considered to be the same or substantially the same.

The processor 111 determines whether or not the accelerating process has been permitted after the process of steps S141 to S143 (step S144). If the accelerating process has been permitted, the processor 111 proceeds to the process of step S171 (FIG. 15).

In step S171, the processor 111 determines whether or not the counted time has become equal to or greater than the second predetermined time. When it is determined that the counted time has become equal to or greater than the second predetermined time, the processor 111 further increases the upper limit speed value by the third predetermined value (step S172). For example, if the upper limit speed value is 5 km/h, the processor 111 increases the upper limit speed value to 6 km/h.

The processor 111 resets the counted time and starts counting the time since the upper limit speed value was further increased by the third predetermined value in step S172 (steps S173 and S174), and returns to the process of step S141 in FIG. 14.

When the decelerating mode described above is turned ON while the electric wheelchair 1 is traveling, the user may feel that the travel feel is desirable if the upper limit speed value is returned to the original large value in a relatively short time. For example, while the electric wheelchair 1 is traveling, the decelerating mode may be turned ON when the electric wheelchair 1 enters a depression in the road. In such cases, the travel feel can be improved by immediately increasing the upper limit speed value by the third predetermined value without waiting for elapse of the second predetermined time since the accelerating process was permitted in step S145.

The processes of the example embodiments described above using FIG. 5 to FIG. 15 can suitably be applied, for example, when the electric wheelchair 1 is traveling downhill. The processes of the example embodiments described above using FIG. 5 to FIG. 15 can suitably be applied, for example, also when decelerating the travel speed of the electric wheelchair 1 based on the user operation on the operation unit 15, for example. For example, the process of an example embodiment can be applied also when the user decelerates the travel speed by relaxing the operation on the stick 16 of the operation unit 15 or returning the stick 16 to the neutral position while the electric wheelchair 1 is traveling.

The processes of the example embodiments described above can be also applied if the electric wheelchair 1 is a power assist wheelchair. For example, the processes of the example embodiments described above can be applied when decelerating the travel speed by detecting the user applying a force to the handrim to reduce or prevent the rotation of the wheels while the power assist wheelchair is traveling.

The processes of the example embodiments described above can be applied also if the electric wheelchair 1 includes an operation unit for a caregiver to operate the electric motors 25L and 25R. For example, the processes of the example embodiments described above can be applied when the caregiver relaxes the operation on the lever of the operation unit or returns the lever to the neutral position to decelerate the travel speed while the electric wheelchair 1 is traveling.

The processes of the example embodiments described above can be applied also to operating the electric motors 25L and 25R using a portable terminal device. For example, the processes of the example embodiments described above can be applied when the user operates the portable terminal device to decelerate the travel speed while the electric wheelchair 1 is traveling.

While the electric wheelchair 1 includes two electric motors 25L and 25R in the description of the example embodiments above, the number of electric motors included in the electric wheelchair 1 is arbitrary, and may be one, or may be three or more.

Illustrative example embodiments of the present invention have been described above. The present specification discloses driving systems, electric wheelchairs, control methods, and non-transitory computer readable media including computer programs as set forth below.

According to an example embodiment of the present invention, a driving system 10 for use in an electric wheelchair 1 includes at least one electric motor 25L and 25R to generate a driving force to cause the electric wheelchair 1 to travel, a battery 7 to supply power to the at least one electric motor 25L and 25R, a controller 110 configured or programmed to control operation of the at least one electric motor 25L and 25R, a speed sensor 26L and 26R to output a signal regarding a travel speed of the electric wheelchair 1, and a current sensor 115 to output a signal regarding a current flowing through an electric path between the at least one electric motor 25L and 25R and the battery 7, wherein the controller 110 is configured or programmed to obtain a current value of a charging current generated by regenerative braking to charge the battery 7, and decelerate the travel speed of the electric wheelchair 1 based on the current value.

According to an example embodiment of the present invention, the travel speed of the electric wheelchair 1 is decelerated based on the current value of the charging current generated by regenerative braking. Thus, it is possible to reduce or prevent the charging current generated by regenerative braking from becoming too large when traveling downhill, for example.

In the driving system 10 above, the controller 110 is configured or programmed to determine whether or not the current value is equal to or greater than a first threshold value, and decelerate the travel speed of the electric wheelchair 1 when it is determined that the current value is equal to or greater than the first threshold value.

By decelerating the travel speed of the electric wheelchair 1 when the current value is equal to or greater than the first threshold value, it is possible to reduce or prevent the charging current from becoming too large.

In the driving system 10 above, the controller 110 is configured or programmed to control operation of the electric motors 25L and 25R so that the travel speed of the electric wheelchair 1 is less than or equal to an upper limit speed value, which is an upper limit value of the travel speed, and decrease the upper limit speed value based on the current value.

It is possible to decelerate the travel speed of the electric wheelchair 1 by decreasing the upper limit speed value.

In the driving system 10 above, the controller 110 is configured or programmed to determine whether or not the current value is equal to or greater than the first threshold value, and decrease the upper limit speed value when it is determined that the current value is equal to or greater than the first threshold value.

The upper limit speed value is decreased when the current value is equal to or greater than the first threshold value thus decelerating the travel speed of the electric wheelchair 1, and it is possible to reduce or prevent the charging current from becoming too large.

In the driving system 10 above, when it is determined that the current value is not equal to or greater than the first threshold value, the controller 110 is configured or programmed to not decrease the upper limit speed value.

By not decreasing the upper limit speed value when the current value is less than the first threshold value, the electric wheelchair 1 can travel at a travel speed that matches the intention of the user.

In the driving system 10 above, when it is determined that the current value is equal to or greater than the first threshold value, the controller 110 is configured or programmed to decrease the upper limit speed value by a first predetermined value.

The upper limit speed value is decreased by the first predetermined value thus decelerating the travel speed of the electric wheelchair 1, and it is possible to reduce or prevent the charging current from becoming too large.

In the driving system 10 above, when it is determined that the current value is equal to or greater than the first threshold value, the controller 110 is configured or programmed to decrease the upper limit speed value by a first predetermined value every first predetermined time.

The upper limit speed value is decreased by the first predetermined value every first predetermined time thus decelerating the travel speed of the electric wheelchair 1, and it is possible to reduce or prevent the charging current from becoming too large.

In the driving system 10 above, when it is determined that the current value is equal to or greater than the first threshold value, the controller 110 is configured or programmed to decrease the upper limit speed value by a first predetermined value, count time since the upper limit speed value was decreased by the first predetermined value, and further decrease the upper limit speed value by the first predetermined value when the counted time has become equal to first predetermined time.

The upper limit speed value is decreased by the first predetermined value every first predetermined time thus decelerating the travel speed of the electric wheelchair 1, and it is possible to reduce or prevent the charging current from becoming too large.

In the driving system 10 above, the controller 110 is configured or programmed to stop a control of decreasing the upper limit speed value based on the current value when the current value is no longer equal to or greater than the first threshold value after it is determined that the current value is equal to or greater than the first threshold value to decrease the upper limit speed value.

By stopping the control of decreasing the upper limit speed value when the charging current becomes small, it is possible to reduce or prevent the travel speed of the electric wheelchair 1 from becoming too low.

In the driving system 10 above, the controller 110 is configured or programmed to determine whether or not the current value is equal to or greater than a second threshold value, which is greater than the first threshold value, and decrease the upper limit speed value by a second predetermined value when it is determined that the current value is equal to or greater than the second threshold value, wherein the second predetermined value is greater than the first predetermined value.

By increasing the rate at which to decelerate the travel speed of the electric wheelchair 1 when the current value is equal to or greater than the second threshold value, it is possible to quickly achieve a state where the charging current is small.

In the driving system 10 above, the first threshold value is smaller than a maximum charging current value of the battery 7.

Because the first threshold value is smaller than the maximum charging current value, even if the charging current increases temporarily during the process of decelerating the travel speed of the electric wheelchair 1, the charging current can be reduced or prevented from exceeding the maximum charging current value.

In the driving system 10 above, the second threshold value is smaller than a maximum charging current value of the battery 7.

Because the second threshold value is smaller than the maximum charging current value, even if the charging current increases temporarily during the process of decelerating the travel speed of the electric wheelchair 1, the current value of the charging current can be reduced or prevented from exceeding the maximum charging current value.

The driving system 10 above further includes a user interface to accept user operations, and the controller 110 is configured or programmed to start a control of decelerating the travel speed of the electric wheelchair 1 based on a user operation on the user interface, and change a rate at which to decelerate the travel speed of the electric wheelchair 1 based on the current value.

Thus, when decelerating the travel speed in response to a user operation, the charging current generated by regenerative braking can be reduced or prevented from becoming too large.

In the driving system 10 above, the controller 110 is configured or programmed to increase the upper limit speed value when the current value has become less than or equal to a third threshold value, which is smaller than the first threshold value, after it is determined that the current value is equal to or greater than the first threshold value to decrease the upper limit speed value.

By increasing the upper limit speed value when the charging current has become sufficiently small, it is possible to reduce or prevent the travel speed from continuing to be restricted to a low speed. For example, it is possible to reduce or prevent the travel speed from continuing to be restricted to a low speed even after moving from a downhill slope to a flat road.

In the driving system 10 above, when it is determined that the current value is less than or equal to the third threshold value, the controller 110 is configured or programmed to count time since it was determined that the current value is less than or equal to the third threshold value, and increase the upper limit speed value by a third predetermined value when the counted time has become equal to second predetermined time.

By increasing the upper limit speed value after elapse of the second predetermined time since it was determined that the current value is less than or equal to the third threshold value, it is possible to reduce or prevent the travel speed from increasing when the charging current decreases temporarily. Moreover, the transition from deceleration to acceleration can be done smoothly.

In the driving system 10 above, after the counted time has become equal to the second predetermined time and the upper limit speed value is increased by the third predetermined value, the controller 110 is configured or programmed to increase the upper limit speed value by the third predetermined value every second predetermined time.

By increasing the upper limit speed value by the third predetermined value every second predetermined time, the travel speed can be smoothly increased.

In the driving system 10 above, when the upper limit speed value has reached a predetermined maximum value, the controller 110 is configured or programmed to stop a control of increasing the upper limit speed value, and maintain the upper limit speed value at the maximum value.

By stopping the control of increasing the upper limit speed value when the upper limit speed value has reached the predetermined maximum value, it is possible to reduce or prevent the travel speed of the electric wheelchair 1 from becoming greater than the maximum value.

In the driving system 10 above, when it is determined that the current value has become greater than the third threshold value after it is determined that the current value is less than or equal to the third threshold value and the upper limit speed value is increased, the controller 110 is configured or programmed to stop the control of increasing the upper limit speed value, and maintain the current upper limit speed value.

By stopping the control of increasing the upper limit speed value when the charging current has become large, it is possible to reduce or prevent the charging current from becoming too large.

In the driving system 10 above, the controller 110 is configured or programmed to decelerate the travel speed of the electric wheelchair 1 at least by regenerative braking.

By charging the battery 7 with the current generated by regenerative braking, it is possible to increase the maximum travel distance of the electric wheelchair 1.

In the driving system 10 above, the controller 110 is configured or programmed to decelerate the travel speed of the electric wheelchair 1 by increasing a braking force generated by regenerative braking based on the current value.

By increasing the braking force generated by regenerative braking, the charging current can increase temporarily, but the regenerative current decreases as the travel speed decreases so the charging current can be decreased.

According to an example embodiment of the present invention, an electric wheelchair 1 includes the driving system 10 according to any of the above.

It is possible to realize the electric wheelchair 1 in which the charging current generated by regenerative braking can be reduced or prevented from becoming too large.

According to an example embodiment of the present invention, a control method to be executed by a computer to control a charging current to charge a battery 7 of an electric wheelchair 1, the battery 7 is configured to supply power to at least one electric motor 25L and 25R to generate a driving force to cause the electric wheelchair 1 to travel, the control method including obtaining a current value of the charging current generated by regenerative braking to charge the battery 7, and decelerating a travel speed of the electric wheelchair 1 based on the current value.

According to an example embodiment of the present invention, the travel speed of the electric wheelchair 1 is decelerated based on the current value of the charging current generated by regenerative braking. Thus, it is possible to reduce or prevent the charging current generated by regenerative braking from becoming too large when traveling downhill, for example.

According to an example embodiment of the present invention, a non-transitory computer readable medium includes a computer program to cause a computer to execute a process of controlling a charging current to charge a battery 7 of an electric wheelchair 1, the battery 7 is configured to supply power to at least one electric motor 25L and 25R to generate a driving force to cause the electric wheelchair 1 to travel, the computer program causing the computer to obtain a current value of the charging current generated by regenerative braking to charge the battery 7, and decelerate a travel speed of the electric wheelchair 1 based on the current value.

According to an example embodiment of the present invention, the travel speed of the electric wheelchair 1 is decelerated based on the current value of the charging current generated by regenerative braking. Thus, it is possible to reduce or prevent the charging current generated by regenerative braking from becoming too large when traveling downhill, for example.

Example embodiments of the present invention are particularly useful in the field of electric wheelchairs.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A driving system for use in an electric wheelchair, the driving system comprising:
at least one electric motor to generate a driving force to cause the electric wheelchair to travel;
a battery to supply power to the at least one electric motor;
a controller configured or programmed to control operation of the at least one electric motor;
a speed sensor to output a signal regarding a travel speed of the electric wheelchair; and
a current sensor to output a signal regarding a current flowing through an electric path between the at least one electric motor and the battery; wherein
the controller is configured or programmed to:
obtain a current value of a charging current generated by regenerative braking to charge the battery; and
decelerate the travel speed of the electric wheelchair based on the current value.

2. The driving system according to claim 1, wherein the controller is configured or programmed to:
determine whether or not the current value is equal to or greater than a first threshold value; and
decelerate the travel speed of the electric wheelchair when it is determined that the current value is equal to or greater than the first threshold value.

3. The driving system according to claim 1, wherein the controller is configured or programmed to:
control operation of the at least one electric motor so that the travel speed of the electric wheelchair is less than or equal to an upper limit speed value, which is an upper limit value of the travel speed; and
decrease the upper limit speed value based on the current value.

4. The driving system according to claim 3, wherein the controller is configured or programmed to:
determine whether or not the current value is equal to or greater than a first threshold value; and
decrease the upper limit speed value when it is determined that the current value is equal to or greater than the first threshold value.

5. The driving system according to claim 4, wherein, when it is determined that the current value is not equal to or greater than the first threshold value, the controller is configured or programmed to not decrease the upper limit speed value.

6. The driving system according to claim 4, wherein, when it is determined that the current value is equal to or greater than the first threshold value, the controller is configured or programmed to decrease the upper limit speed value by a first predetermined value.

7. The driving system according to claim 4, wherein, when it is determined that the current value is equal to or greater than the first threshold value, the controller is configured or programmed to decrease the upper limit speed value by a first predetermined value every first predetermined time.

8. The driving system according to claim 4, wherein, when it is determined that the current value is equal to or greater than the first threshold value, the controller is configured or programmed to:
decrease the upper limit speed value by a first predetermined value;
count time since the upper limit speed value was decreased by the first predetermined value; and
further decrease the upper limit speed value by the first predetermined value when the counted time has become equal to first predetermined time.

9. The driving system according to claim 4, wherein the controller is configured or programmed to stop a control of decreasing the upper limit speed value based on the current value when the current value is no longer equal to or greater than the first threshold value after it is determined that the current value is equal to or greater than the first threshold value to decrease the upper limit speed value.

10. The driving system according to claim 6, wherein the controller is configured or programmed to:
determine whether or not the current value is equal to or greater than a second threshold value, which is greater than the first threshold value; and
decrease the upper limit speed value by a second predetermined value when it is determined that the current value is equal to or greater than the second threshold value; and
the second predetermined value is greater than the first predetermined value.

11. The driving system according to claim 4, wherein the first threshold value is smaller than a maximum charging current value of the battery.

12. The driving system according to claim 10, wherein the second threshold value is smaller than a maximum charging current value of the battery.

13. The driving system according to claim 1, further comprising:
a user interface to accept user operations; wherein
the controller is configured or programmed to:
start a control to decelerate the travel speed of the electric wheelchair based on a user operation on the user interface; and
change a rate at which to decelerate the travel speed of the electric wheelchair based on the current value.

14. The driving system according to claim 4, wherein the controller is configured or programmed to increase the upper limit speed value when the current value has become less than or equal to a third threshold value, which is smaller than the first threshold value, after it is determined that the current value is equal to or greater than the first threshold value to decrease the upper limit speed value.

15. The driving system according to claim 14, wherein, when it is determined that the current value is less than or equal to the third threshold value, the controller is configured or programmed to:
count time since it was determined that the current value is less than or equal to the third threshold value; and
increase the upper limit speed value by a third predetermined value when the counted time has become equal to second predetermined time.

16. The driving system according to claim 15, wherein, after the counted time has become equal to the second predetermined time and the upper limit speed value is increased by the third predetermined value, the controller is configured or programmed to increase the upper limit speed value by the third predetermined value every second predetermined time.

17. The driving system according to claim 14, wherein, when the upper limit speed value has reached a predetermined maximum value, the controller is configured or programmed to stop a control of increasing the upper limit speed value, and maintain the upper limit speed value at the maximum value.

18. The driving system according to claim 14, wherein, when it is determined that the current value has become greater than the third threshold value after it is determined that the current value is less than or equal to the third threshold value and the upper limit speed value is increased, the controller is configured or programmed to stop the control of increasing the upper limit speed value, and maintain the current upper limit speed value.

19. The driving system according to claim 1, wherein the controller is configured or programmed to decelerate the travel speed of the electric wheelchair at least by regenerative braking.

20. The driving system according to claim 19, wherein the controller is configured or programmed to decelerate the travel speed of the electric wheelchair by increasing a braking force generated by the regenerative braking based on the current value.

21. An electric wheelchair comprising:
the driving system according to claim 1.

22. A control method to be executed by a computer for controlling a charging current to charge a battery of an electric wheelchair, the battery configured to supply power to at least one electric motor to generate a driving force to cause the electric wheelchair to travel, the control method comprising:
obtaining a current value of the charging current generated by regenerative braking to charge the battery; and
decelerating a travel speed of the electric wheelchair based on the current value.

23. A non-transitory computer readable medium including a computer program to cause a computer to execute a process of controlling a charging current to charge a battery of an electric wheelchair, the battery configured to supply power to at least one electric motor to generate a driving force to cause the electric wheelchair to travel, the computer program causing the computer to:
obtain a current value of the charging current generated by regenerative braking to charge the battery; and
decelerate a travel speed of the electric wheelchair based on the current value.
